(19) United States
(12) Patent Application Publication
(10) Pub. No.: US 2026/0029747 A1
(43) Pub. Date: Jan. 29, 2026

(54) IMAGE-FORMING APPARATUS INCLUDING LINKAGE FOR MOVING RECEPTACLE TOWARD AND AWAY FROM OPENING IN FIRST COVER IN INTERLOCKING RELATION TO MOVEMENT OF SECOND COVER

(71) Applicant: BROTHER KOGYO KABUSHIKI KAISHA, Nagoya (JP)

(72) Inventors: Masahiko HAYAKAWA, Ama (JP); Shougo SATO, Seto (JP)

(73) Assignee: BROTHER KOGYO KABUSHIKI KAISHA, Nagoya (JP)

(21) Appl. No.: 19/232,364

(22) Filed: Jun. 9, 2025

(30) Foreign Application Priority Data
Jul. 24, 2024 (JP) 2024-118931

(51) Int. Cl. G03G 21/18; G03G 21/16

(52) U.S. Cl. CPC G03G 21/1842; G03G 21/1633; G03G 21/1814; G03G 21/1832

(57) ABSTRACT

An image-forming apparatus includes: a main housing; a drum unit; a developing unit; a first cover; a second cover; and a linkage. The developing unit includes a receptacle and a unit-side shutter. The first cover is movable for closing and exposing a first opening in the main housing. The first cover includes an operating member for opening and closing the unit-side shutter. The second cover is on the first cover and is movable for closing and exposing a second opening in the first cover. The linkage can move the receptacle between: a first position apart from the second opening; and a second position closer to the second opening. While the first cover is closed, closing movement of the second cover causes the linkage to move the receptacle to the first position; and opening movement of the second cover causes the linkage to move the receptacle to the second position.

### REFERENCE TO RELATED APPLICATIONS

This application claims priority from Japanese Patent Application No. 2024-118931 filed on Jul. 24, 2024. The entire content of the priority application is incorporated herein by reference.

### BACKGROUND ART

There has been known an image-forming apparatus that includes a main housing in which a developing unit is accommodated. The main housing has a first opening, and includes a cover for opening and closing the first opening. The developing unit has a supply port to which a toner pack storing toner is attachable through a second opening formed in the cover. In this image-forming apparatus, the toner pack attached to the supply port is rotated 180 degrees to open a shutter member of the toner pack, thereby enabling the toner in the toner pack to be supplied into the developing unit.

In the image-forming apparatus having the above-described configuration, if the toner pack is formed as a resin bag that is easily deformable, the toner pack may change its shape as the toner pack attached to the supply port is rotated, worsening workability of the toner pack. One possible method of resolving this problem is to provide an operating member on the developing unit for rotating the shutter member of the toner pack.

### SUMMARY

However, in a case where the operating member is disposed on the developing unit, the operating member would be positioned under the cover inside the main housing. Hence, a user may have difficulty in manipulating the operating member. Moreover, if the supply port of the developing unit, which is accommodated inside the main housing, is located far apart from the second opening formed in the cover, the user may also have difficulty in attaching the toner pack to the supply port of the developing unit.

Further, in a case where the developing unit is designed to be mounted in the main housing through the first opening, the operating member could interfere user's operation for mounting the developing unit through the first opening if the operating member is positioned near the first opening of the main housing.

In view of the foregoing, it is an object of the present disclosure to provide an image-forming apparatus capable of facilitating operations for mounting a toner container on a developing unit and opening/closing the shutter member of the toner container for replenishing the developing unit with toner, while also facilitating the operations for mounting the developing unit in the main housing.

In order to attain the above and other objects, the present disclosure provides an image-forming apparatus including a main housing, a drum unit, a developing unit, a first cover, a second cover, and a linkage. The main housing has a first opening. The drum unit is mountable in and removable from the main housing through the first opening. The drum unit includes a photosensitive drum. The developing unit is mountable in and removable from the main housing through the first opening. The developing unit is movable relative to the drum unit. The developing unit includes a receptacle, and a unit-side shutter. To the receptacle, a discharging part of a toner container storing toner is connectable. The unit-side shutter is configured to open and close the receptacle. The first cover is disposed at the main housing and is movable relative to the main housing between a first closed position for closing the first opening and a first open position for exposing the first opening. The first cover has a second opening configured to communicate with the receptacle. The first cover includes an operating member configured to open and close the unit-side shutter. The second cover is disposed on the first cover and is movable relative to the first cover between a second closed position for closing the second opening and a second open position for exposing the second opening. The linkage is configured to move the receptacle, relative to the first cover, between: a first position in which the receptacle is spaced apart from the second opening; and a second position in which the receptacle is closer to the second opening than when in the first position. In a state where the first cover is in the first closed position, movement of the second cover to the second closed position causes the linkage to move the receptacle to the first position, and movement of the second cover to the second open position causes the linkage to move the receptacle to the second position.

With this configuration, operations for attaching a toner container to the developing unit and opening/closing a shutter of the toner container can be facilitated. Further, operations for mounting the developing unit in the main housing can also be facilitated.

### BRIEF DESCRIPTION OF DRAWINGS

FIG. 1 is a central cross-sectional view of an image-forming apparatus in a state where a top cover is in a first closed position thereof and a refill cover is in a second closed position thereof.

FIG. 2 is a central cross-sectional view of the image-forming apparatus in a state where the top cover is in the first closed position and the refill cover is in a second open position thereof.

FIG. 3 is a central cross-sectional view of the image-forming apparatus in a state where the top cover is in a first open position thereof and a process cartridge is ready to be removed from a main housing through an opening thereof.

FIG. 4 is a plan view illustrating an exposure unit and the process cartridge in the image-forming apparatus.

FIG. 5 is a cross-sectional side view illustrating a receptacle and a linkage in the image-forming apparatus in a state where the top cover is in the first open position and the refill cover is in the second closed position.

FIG. 6 is a plan view of the receptacle and the linkage.

FIG. 7 is a cross-sectional side view illustrating the receptacle and the linkage in the state where the top cover is in the first closed position and the refill cover is in the second open position.

FIG. 8A is a cross-sectional side view illustrating an operating member in its first operating position and a unit-side shutter in its first shutter closed position.

FIG. 8B is a plan view illustrating the operating member in its first operating position and the unit-side shutter in its first shutter closed position.

FIG. 9A is a cross-sectional side view illustrating the operating member in its second operating position and the unit-side shutter in its first shutter open position.

FIG. 9B is a plan view illustrating the operating member in its second operating position and the unit-side shutter in its first shutter open position.

FIG. 10A is a left side view of a toner container in a state where a container-side shutter thereof is in its second shutter closed position.

FIG. 10B is a right side view of the toner container in the state where the container-side shutter is in its second shutter closed position.

FIG. 11A is a cross-sectional view of the toner container as viewed from its left side in the state where the container-side shutter is in its second shutter closed position.

FIG. 11B is a cross-sectional view of the toner container as viewed from its right side in the state where the container-side shutter is in its second shutter closed position.

FIG. 12A is a bottom view of the toner container in the state where the container-side shutter is in its second shutter closed position.

FIG. 12B is a bottom view of the toner container in a state where the container-side shutter is in a second shutter open position thereof.

FIG. 13 is a cross-sectional side view of the image-forming apparatus in a state where a discharging part of the toner container is connected to the receptacle of the process cartridge and the operating member is in its first operating position.

FIG. 14 is a plan view illustrating the operating member in its second operating position and the unit-side shutter in its first shutter closed position.

### DESCRIPTION

Hereinafter, an embodiment of the present disclosure will be described while referring to the accompanying drawings.

### [Image-Forming Apparatus]

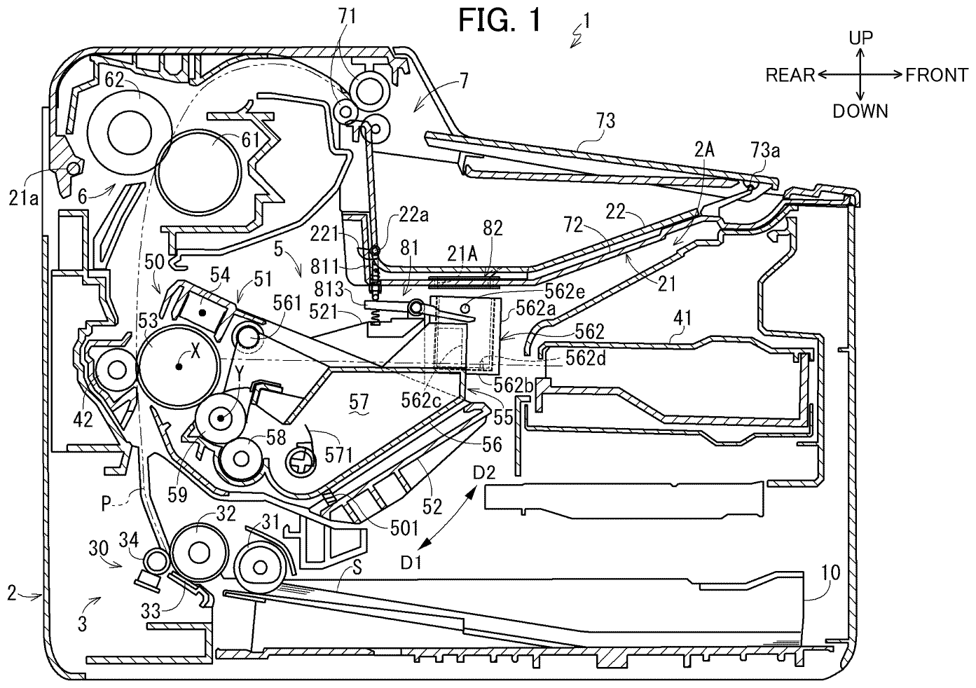

An image-forming apparatus 1 illustrated in FIG. 1 is an image-forming apparatus according to one embodiment of the present disclosure. Specifically, the image-forming apparatus 1 is a laser printer configured to form images on sheets S according to the electrophotographic method.

In the following description, the right side in FIG. 1 is defined as the front side of the image-forming apparatus 1, the left side in FIG. 1 is defined as the rear side of the image-forming apparatus 1, the near side in FIG. 1 is defined as the left side of the image-forming apparatus 1, and the far side in FIG. 1 is defined as the right side of the image-forming apparatus 1. Further, the top and bottom sides in FIG. 1 are defined as the top and bottom of the image-forming apparatus 1, respectively.

The image-forming apparatus 1 includes a main housing 2, a sheet-feeding unit 3, an image-forming unit 5, a fixing device 6, and a discharge unit 7. The main housing 2 accommodates the sheet-feeding unit 3, the image-forming unit 5, the fixing device 6, and the discharge unit 7. The main housing 2 is an example of “main housing” of the disclosure.

As illustrated in FIGS. 1 through 3, an opening 2A is formed in a front-upper end portion of the main housing 2. The main housing 2 includes a top cover 21 that can open and close the opening 2A. The opening 2A is an example of “first opening” of the disclosure. The top cover 21 is an example of “first cover” of the disclosure.

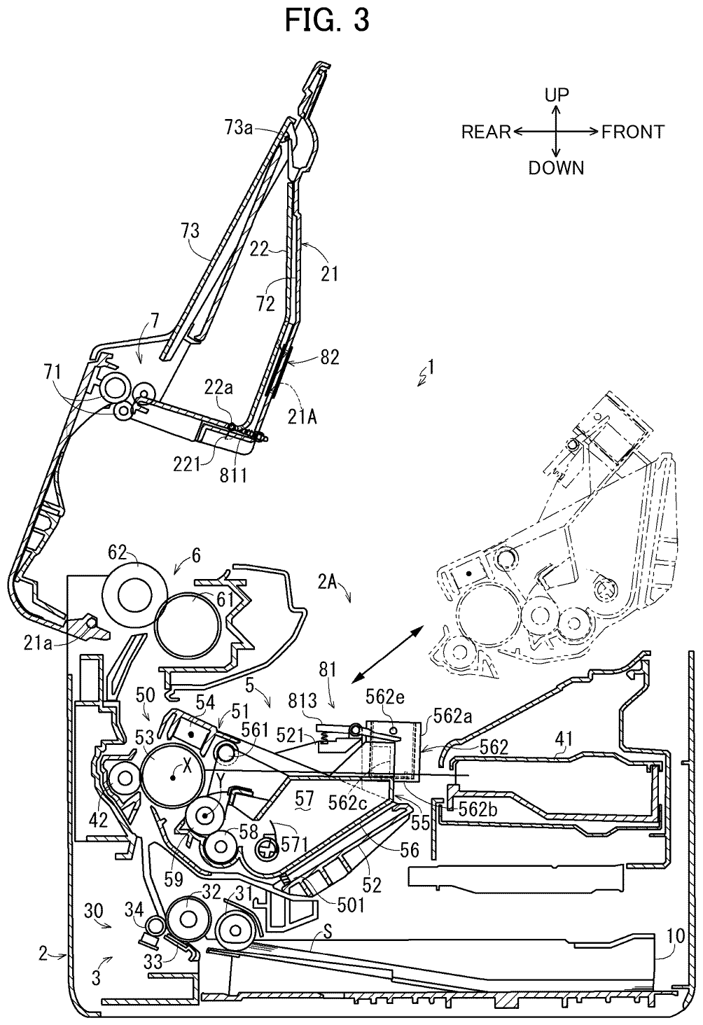

The top cover 21 is pivotable about an axis of a pivot shaft 21a disposed at a rear end of the top cover 21. The pivot shaft 21a extends in a left-right direction. By pivoting about the axis of the pivot shaft 21a, the top cover 21 is movable between a first closed position (illustrated in FIG. 1) for covering the opening 2A and a first open position (illustrated in FIG. 3) for exposing the opening 2A.

The sheet-feeding unit 3 includes a sheet tray 10 configured to support the sheets S, and a sheet conveying unit 30. The sheet-feeding unit 3 is arranged in a bottom section of the main housing 2. The sheet-feeding unit 3 is configured to convey the sheets S supported on the sheet tray 10 to the image-forming unit 5. The image-forming apparatus 1 has a conveying path P for conveying the sheets S from the sheet-feeding unit 3 to the discharge unit 7 through the image-forming unit 5.

The sheet conveying unit 30 is a conveying mechanism that functions to pick up the sheets S accommodated in the sheet tray 10, separate the sheets S one by one, and convey each separated sheet S toward the image-forming unit 5. The sheet conveying unit 30 includes a feed roller 31, a separating roller 32, a separating pad 33, and a conveying roller 34.

The feed roller 31 is configured to feed the sheets S supported on the sheet tray 10 toward the separating roller 32. The separating roller 32 is arranged downstream of the feed roller 31 in a sheet conveying direction. The separating pad 33 is arranged to face the separating roller 32 and is urged toward the separating roller 32.

The sheets S fed toward the separating roller 32 by the feed roller 31 are separated one by one between the separating roller 32 and the separating pad 33. Each separated sheet S is then conveyed onto the conveying path P by the conveying roller 34. The sheet S conveyed onto the conveying path P is then conveyed toward the image-forming unit 5.

The image-forming unit 5 is disposed downstream of the sheet-feeding unit 3 in the sheet conveying direction. The image-forming unit 5 is configured to form images on the sheets S conveyed from the sheet-feeding unit 3. The image-forming unit 5 includes a process cartridge 50 configured to transfer an image onto a surface of each sheet S conveyed from the sheet-feeding unit 3, and an exposure unit 41 configured to expose a surface of a photosensitive drum 53 disposed in the process cartridge 50 to light.

The process cartridge 50 is detachably mountable in the main housing 2. The process cartridge 50 includes a drum unit 51, and a developing unit 55. The process cartridge 50 is mounted in the main housing 2 with the developing unit 55 attached to the drum unit 51. When mounted in the main housing 2, the process cartridge 50 is positioned above the sheet-feeding unit 3. The developing unit 55 is not detachable relative to the drum unit 51. The drum unit 51 is an example of “drum unit” of the disclosure. The developing unit 55 is an example of “developing unit” of the disclosure.

The drum unit 51 includes the photosensitive drum 53, a charging device 54, and a transfer roller 42. The developing unit 55 has a toner chamber 57, a supply roller 58, and a developing roller 59.

As illustrated in FIG. 3, the opening 2A of the main housing 2 allows passage of the process cartridge 50. Therefore, by moving the top cover 21 into the first open position, the process cartridge 50 can easily be mounted in and removed from the main housing 2 through the opening 2A. The process cartridge 50 mounted in the main housing 2 is to be removed from the main housing 2 when the process cartridge 50 needs to be replaced or when a sheet S causes a paper jam near the photosensitive drum 53 and the transfer roller 42, for example.

The process cartridge 50 is configured to be mounted in the main housing 2 by inserting the drum unit 51 and the developing unit 55 attached to the drum unit 51 together into the main housing 2. That is, the drum unit 51 is configured to be inserted into the main housing 2 through the opening 2A, and the developing unit 55 is configured to be inserted into the main housing 2 through the opening 2A.

The process cartridge 50 is configured to be removed from the main housing 2 by pulling the drum unit 51 and the developing unit 55 attached to the drum unit 51 together from the main housing 2.

In a state where the process cartridge 50 is mounted in the main housing 2, the photosensitive drum 53 is arranged in such an orientation that a rotational axis X thereof is aligned in the left-right direction. The photosensitive drum 53 is rotatable about the rotational axis X.

In the state where the process cartridge 50 is mounted in the main housing 2, the developing roller 59 is arranged in such an orientation that a rotational axis Y thereof is aligned in the left-right direction. The developing roller 59 is rotatable about the rotational axis Y. The rotational axis Y of the developing roller 59 is parallel to the rotational axis X of the photosensitive drum 53.

Alternatively, the drum unit 51 possessing the photosensitive drum 53 and the developing unit 55 possessing the developing roller 59 may be configured to be mounted separately in the main housing 2 of the image-forming apparatus 1.

The exposure unit 41 includes a laser diode, a polygon mirror, lenses, and reflecting mirrors. The exposure unit 41 is configured to expose the surface of the photosensitive drum 53 to light by emitting a laser light toward the photosensitive drum 53 based on image data inputted into the image-forming apparatus 1.

The toner chamber 57 is configured to store toner as a developer. The toner accommodated in the toner chamber 57 is configured to be supplied onto the supply roller 58 while being agitated by an agitator 571. The supply roller 58 is configured to supply the toner received from the toner chamber 57 to the developing roller 59.

The developing roller 59 is arranged in close contact with the supply roller 58. The developing roller 59 is configured to carry the toner supplied from the supply roller 58 while the toner is positively charged between portions of the supply roller 58 and developing roller 59 that slidingly contact with each other. Further, the developing roller 59 is configured to be applied with a developing bias by a bias applying means (not illustrated).

The photosensitive drum 53 is arranged adjacent to the developing roller 59. The surface of the photosensitive drum 53 is configured to be exposed to light by the exposure unit 41 after being uniformly charged by the charging device 54. The exposed areas on the photosensitive drum 53 have a lower potential than other areas, enabling an electrostatic latent image to be formed on the photosensitive drum 53 based on image data. Subsequently, the positively charged toner is supplied from the developing roller 59 onto the surface of the photosensitive drum 53 on which the electrostatic latent image was formed, thereby developing the electrostatic latent image into a visible toner image.

The transfer roller 42 is arranged to face the photosensitive drum 53. The transfer roller 42 is configured to be applied with a transfer bias by a bias applying means (not illustrated). As the transfer bias is applied to the surface of the transfer roller 42, a sheet S is conveyed while nipped between the transfer roller 42 and the photosensitive drum 53 on which a toner image has been formed. At this time the toner image formed on the surface of the photosensitive drum 53 is transferred onto the surface of the sheet S. After the toner image has been transferred, the sheet S is conveyed to the fixing device 6.

The fixing device 6 includes a heating roller 61, and a pressure roller 62. The image transferred onto the sheet S by the process cartridge 50 is configured to be fixed to the sheet S in the fixing device 6. The heating roller 61 is configured to be heated upon receipt of power from a power source (not illustrated). The pressure roller 62 is arranged to face the heating roller 61. One of the heating roller 61 and pressure roller 62 is urged toward the other by an urging mechanism (not illustrated) so that the heating roller 61 and pressure roller 62 are in close contact with each other.

When a sheet S having a toner image transferred thereon is conveyed to the fixing device 6, the sheet S becomes nipped between the heating roller 61 and pressure roller 62. While the heating roller 61 and pressure roller 62 convey the sheet S with the sheet S nipped therebetween, the heating roller 61 heats the sheet S to thermally fix the toner image thereon. In this way, the toner image is fixed to the sheet S in the fixing device 6. After the toner image is fixed to the sheet S, the sheet S is conveyed to the discharge unit 7.

The discharge unit 7 is located downstream of the fixing device 6 in the sheet conveying direction. The discharge unit 7 is configured to discharge the sheets S outside of the image-forming apparatus 1 after an image is formed on each sheet S at the image-forming unit 5. The discharge unit 7 includes a discharge roller pair 71, and a discharge tray 72, and an extension tray 73. The discharge roller pair 71, discharge tray 72, and extension tray 73 are disposed on the top cover 21. The discharge roller pair 71 is configured to discharge each sheet S conveyed from the fixing device 6 along the conveying path P toward the outside of the main housing 2. The discharge tray 72 is configured to support each sheet S discharged out of the main housing 2 by the discharge roller pair 71.

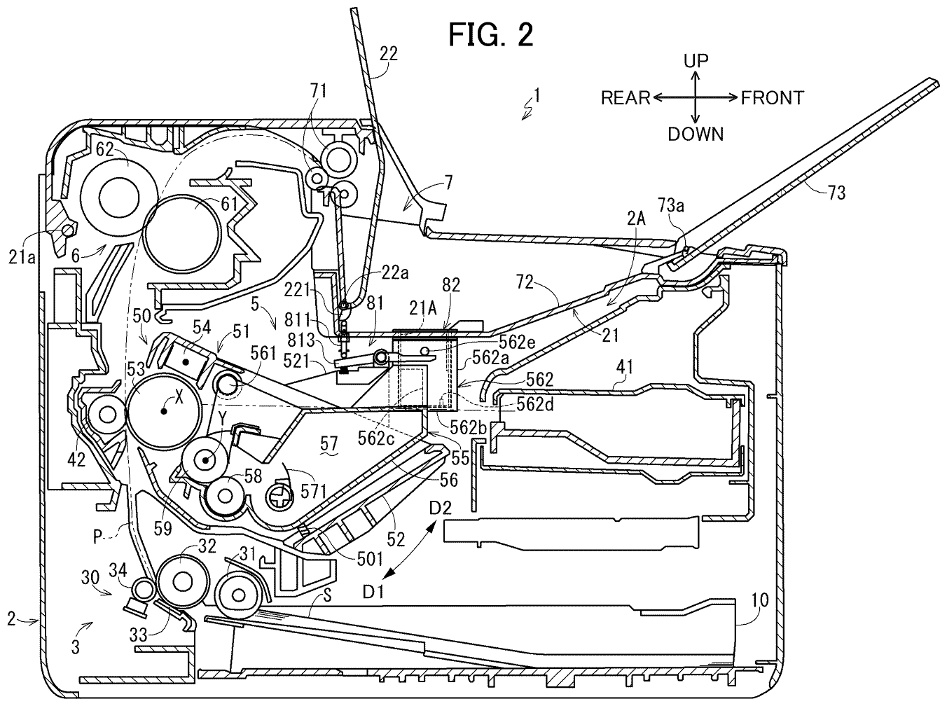

The extension tray 73 is configured to pivot about a pivot axis 73a. The extension tray 73 is movable between a folded position (illustrated in FIG. 1) and an extended position (illustrated in FIG. 2). In the folded position, the extension tray 73 has been pivoted rearward and folded over the top of the discharge tray 72. In the extended position, the extension tray 73 has been pivoted forward and unfolded to the front of the discharge tray 72. While being in the extended position, the extension tray 73, together with the discharge tray 72, can support the sheets S discharged out of the main housing 2.

### [Process Cartridge]

As illustrated in FIGS. 1 through 4, the process cartridge 50 is detachably mounted in the main housing 2. In the state where the process cartridge 50 is mounted in the main housing 2, the process cartridge 50 is housed inside the main housing 2. As described above, the process cartridge 50 includes the drum unit 51 and the developing unit 55. In other words, the drum unit 51 and developing unit 55 constitute the process cartridge 50.

In the state where the process cartridge 50 is mounted in the main housing 2, the drum unit 51 is fixed in position relative to the main housing 2. The developing unit 55 is movable relative to the drum unit 51.

### (Drum Unit)

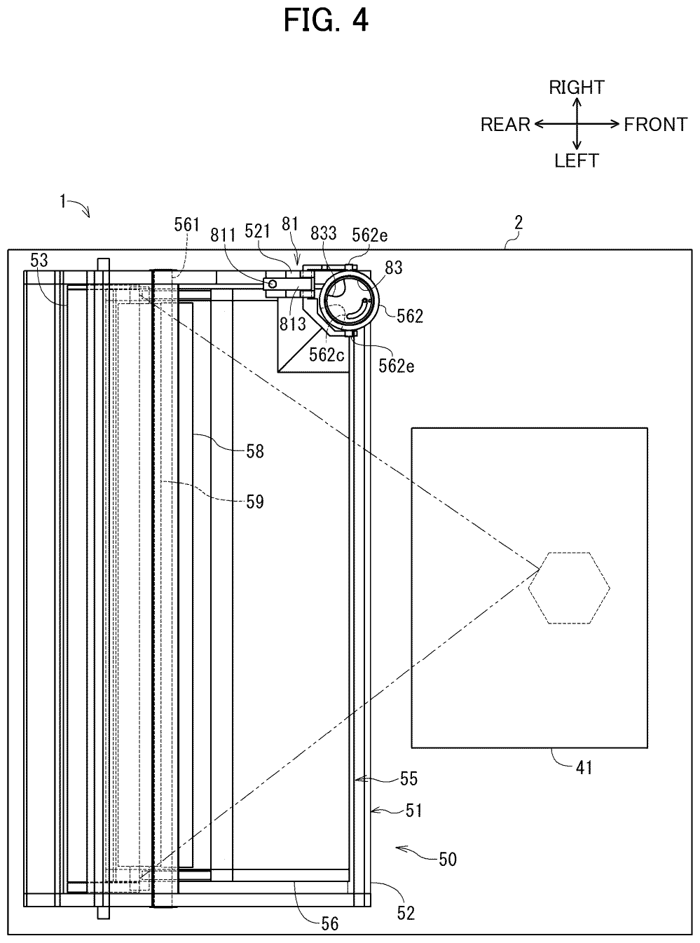

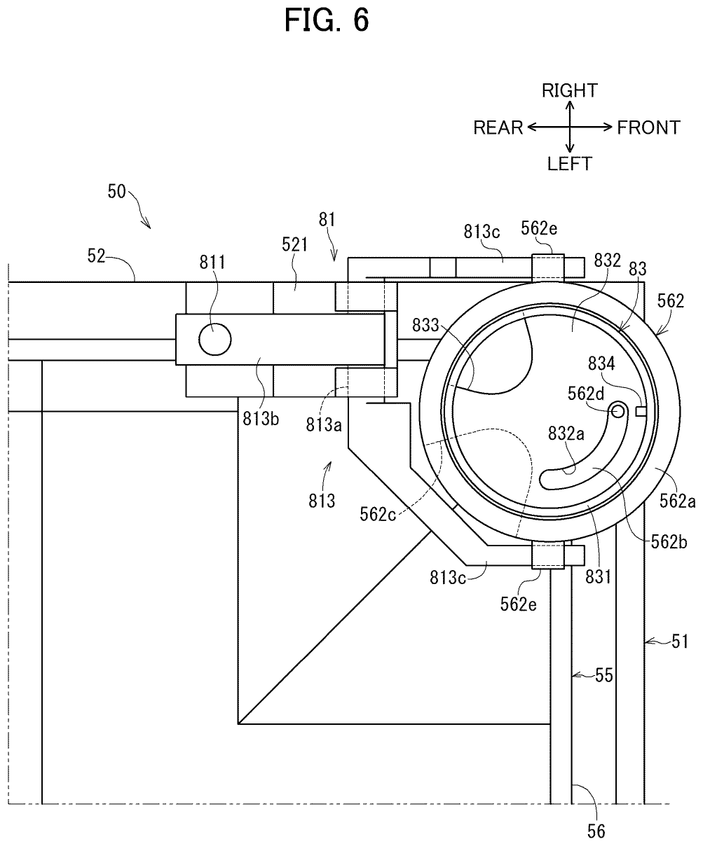

The drum unit 51 further includes a drum frame 52, in addition to the above-described photosensitive drum 53, charging device 54, and transfer roller 42. The drum frame 52 supports the photosensitive drum 53, charging device 54, and transfer roller 42. The photosensitive drum 53, charging device 54, and transfer roller 42 are arranged at a rear end portion of the drum unit 51 in a front-rear direction. The drum frame 52 has a support base 521. The support base 521 is disposed at a right end portion of the drum frame 52 on a front end portion thereof (see FIGS. 4 and 6). That is, the support base 521 is at a front-right corner portion of the drum frame 52.

### (Developing Unit)

The developing unit 55 further includes a developing unit frame 56, in addition to the supply roller 58 and developing roller 59. The developing unit frame 56 supports the supply roller 58 and developing roller 59. The supply roller 58 and developing roller 59 are disposed at a rear end portion of the developing unit 55. The toner chamber 57 is formed in an interior of the developing unit frame 56.

The developing unit frame 56 is supported by the drum frame 52 through a pivot pin 561. The pivot pin 561 extends in the left-right direction and pivotably supports the developing unit frame 56. As illustrated in FIGS. 1 and 2, by pivoting about an axis of the pivot pin 561, the developing unit frame 56 is movable in a first direction D1 (in which the developing roller 59 moves toward the photosensitive drum 53) and a second direction D2 (in which the developing roller 59 moves away from the photosensitive drum 53). In other words, the developing unit 55 is movable, relative to the drum unit 51 and photosensitive drum 53, in the first direction D1 and the second direction D2 opposite the first direction D1.

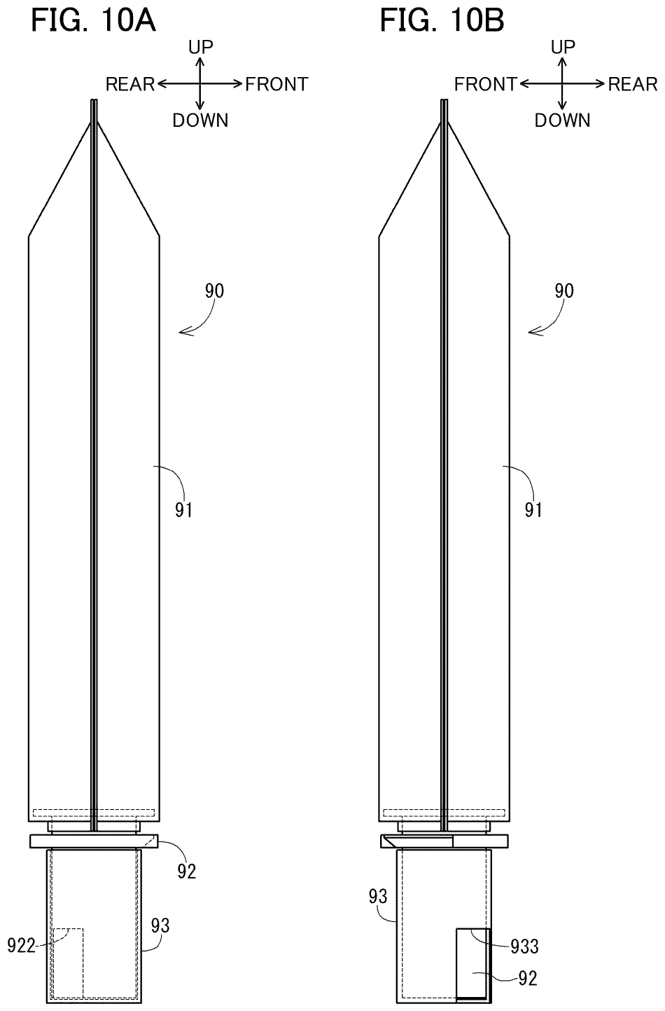

The developing unit frame 56 includes a receptacle 562. The receptacle 562 is a part to which a toner container 90 is connectable (see FIG. 10) for replenishing the process cartridge 50 with toner. The receptacle 562 is positioned on an upper end portion of the developing unit frame 56 at a front end portion thereof. That is, the receptacle 562 is at a front-upper corner portion of the developing unit frame 56. With respect to the left-right direction, the receptacle 562 is located on a right end portion of the developing unit frame 56. The receptacle 562 is an example of “receptacle” of the disclosure.

The receptacle 562 includes a cylindrical portion 562a, a bottom portion 562b, a supply port 562c, and an anchoring pin 562d.

The cylindrical portion 562a is formed in a cylindrical shape that extends in an up-down direction. The cylindrical portion 562a has an open upper end. The bottom portion 562b is a plate-shaped member that closes a bottom end of the cylindrical portion 562a. The supply port 562c is open on a left-rear side wall of the cylindrical portion 562a as well as a left-rear area of the bottom portion 562b.

The supply port 562c is in communication with the toner chamber 57. The anchoring pin 562d is a pin that protrudes upward from a top surface of the bottom portion 562b. The anchoring pin 562d is an example of “third engaging part” of the disclosure.

### (Compression Springs)

Compression springs 501 are interposed between the drum frame 52 and the developing unit frame 56 in a lower-front portion of the process cartridge 50. The compression springs 501 urge the developing unit frame 56 in the first direction D1 relative to the drum frame 52.

Through urging forces of the compression springs 501, the developing roller 59 is pressed toward the photosensitive drum 53. This configuration can absorb any outer diameter run-out in the developing roller 59, ensuring smooth rotation of the developing roller 59.

### [Top Cover and Refill Cover]

As illustrated in FIGS. 1 and 2, the top cover 21 has an opening 21A. The opening 21A extends through the top cover 21 in the up-down direction in a state where the top cover 21 is in the first closed position. The opening 21A has a circular shape. When the top cover 21 is in the first closed position, the opening 21A is positioned upward of the receptacle 562 of the developing unit 55. The opening 21A is an example of “second opening” of the disclosure.

The main housing 2 also includes a refill cover 22. The refill cover 22 is disposed on the top cover 21 for opening and closing the opening 21A. The refill cover 22 is pivotable about an axis of a pivot shaft 22a extending in the left-right direction. The pivot shaft 22a is located on a rear end of the refill cover 22. By pivoting about the axis of the pivot shaft 22a, the refill cover 22 is movable between a second closed position (illustrated in FIG. 1) for closing the opening 21A, and a second open position (illustrated in FIG. 2) for exposing the opening 21A. The refill cover 22 is an example of “second cover” of the disclosure.

In the state where the top cover 21 is in the first closed position, the receptacle 562 of the developing unit 55 is positioned beneath the opening 21A in the top cover 21 and the opening 21A is in communication with the receptacle 562. While the top cover 21 is in the first closed position and the refill cover 22 is in the second open position, the receptacle 562 is exposed outside the main housing 2 through the opening 21A. Hence, by moving the refill cover 22 to the second open position while the top cover 21 is in the first closed position, the toner container 90 can be easily mounted in and removed from the receptacle 562 through the opening 21A.

Further, while the top cover 21 is in the first closed position and the refill cover 22 is in the second closed position, the refill cover 22 covers the receptacle 562 and the opening 21A from above. Therefore, by moving the refill cover 22 to the second closed position while the top cover 21 is in the first closed position, dust or other foreign matters can be restrained from entering the receptacle 562.

### [Linkage]

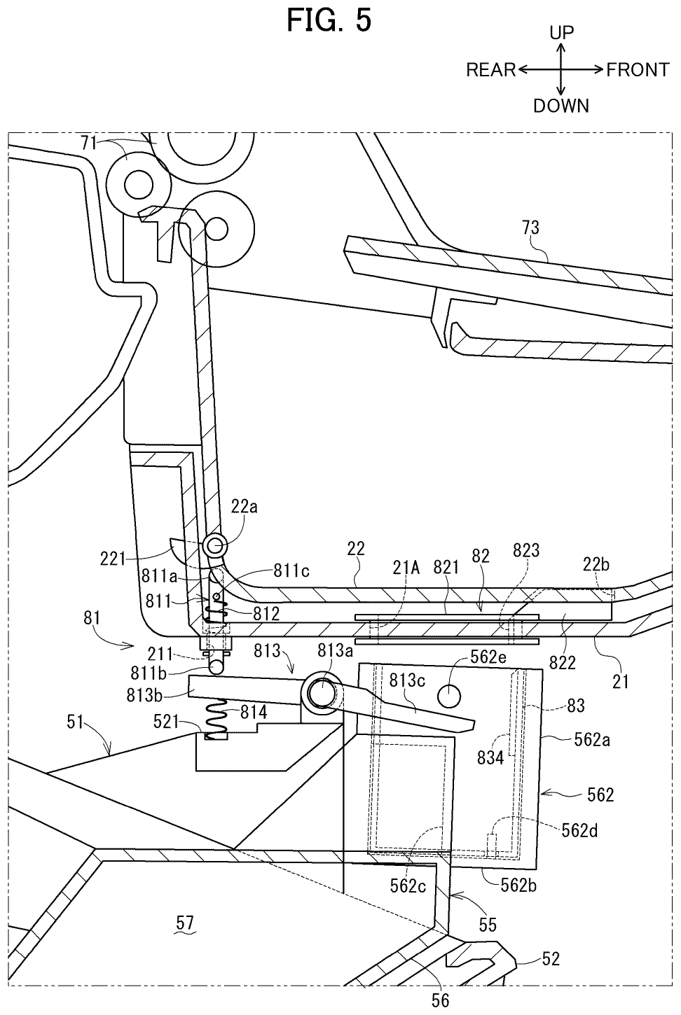

As illustrated in FIGS. 5 through 7, the image-forming apparatus 1 further includes a linkage 81 for moving the receptacle 562 relative to the opening 21A. Specifically, the linkage 81 is configured to move the receptacle 562 of the developing unit 55 between a first position and a second position relative to the opening 21A of the top cover 21. In the first position, the receptacle 562 is spaced apart from the opening 21A of the top cover 21. The receptacle 562 is positioned closer to the opening 21A in the second position than in the first position. The linkage 81 is an example of “linkage” of the disclosure.

The linkage 81 includes a cam 221, an interlocking pin 811, a first spring 812, an interlocking arm 813, a second spring 814, and a pair of force-receiving pins 562e. The cam 221 is an example of “first member” of the disclosure. The interlocking pin 811 is an example of “first interlocking member” of the disclosure, the interlocking arm 813 is an example of “second interlocking member” of the disclosure, and the force-receiving pins 562e are an example of “second member” of the disclosure. The second spring 814 is an example of “urging member” of the disclosure. The first spring 812 is an example of another “urging member” of the disclosure.

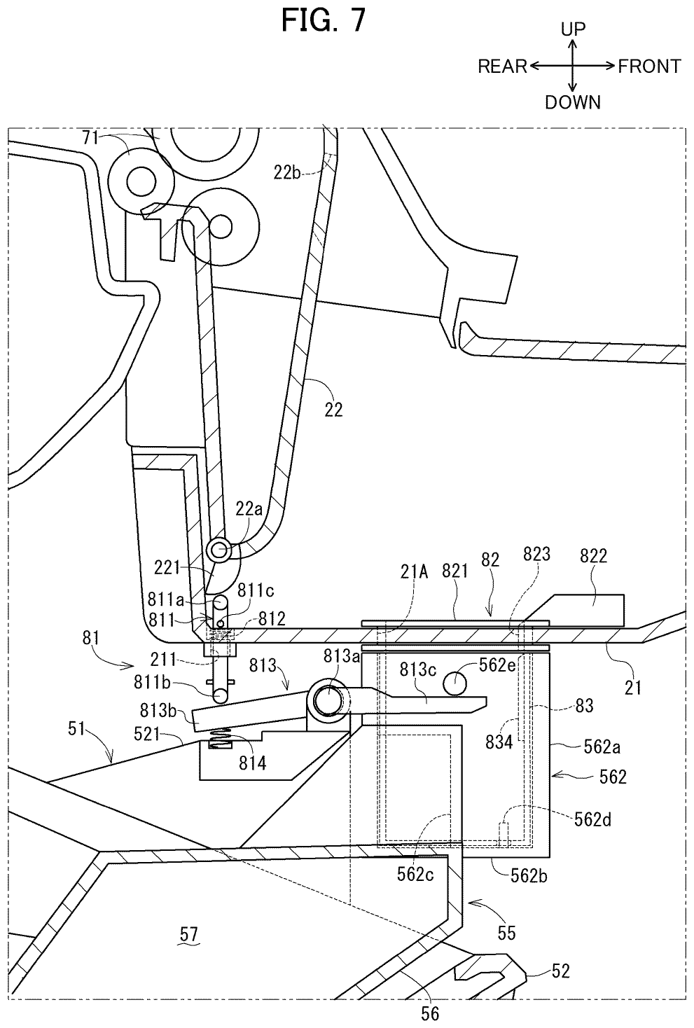

The cam 221 is disposed at the refill cover 22. The cam 221 protrudes from the pivot shaft 22a. Specifically, the cam 221 protrudes rearward from the pivot shaft 22a when the refill cover 22 is in the second closed position (see FIG. 5). The cam 221 protrudes downward from the pivot shaft 22a when the refill cover 22 is in the second open position (see FIG. 7).

The interlocking pin 811 is a pin member extending in the up-down direction. The interlocking pin 811 is disposed on the top cover 21. The interlocking pin 811 is inserted in a through-hole 211 formed in the top cover 21 such that the interlocking pin 811 is movable in the up-down direction inside the through-hole 211. The interlocking pin 811 has an upper end 811a, a lower end 811b, and an anchoring part 811c. The upper end 811a protrudes further upward relative to the through-hole 211 and is configured to abut on the cam 221. The lower end 811b protrudes further downward relative to the through-hole 211. The anchoring part 811c is a part of the interlocking pin 811 positioned above the through-hole 211.

The first spring 812 is a compression spring interposed between the anchoring part 811c and the top cover 21. The first spring 812 urges the interlocking pin 811 in such a direction that the upper end 811a of the interlocking pin 811 moves away from the top cover 21. When the top cover 21 is in the first closed position, the interlocking pin 811 is urged upward by the first spring 812.

The interlocking pin 811 is movable between a third position and a fourth position in the up-down direction, the fourth position being further downward than the third position. In the third position, the interlocking pin 811 has been moved upward by the urging force of the first spring 812. The interlocking pin 811 is located further downward in the fourth position than in the third position against the urging force of the first spring 812.

The interlocking arm 813 has a pivot shaft 813a, a pressure-receiving arm 813b, and a pair of operating arms 813c. The pivot shaft 813a is supported by the support base 521 of the drum frame 52 such that the interlocking arm 813 is pivotable about an axis of the pivot shaft 813a. The pressure-receiving arm 813b extends rearward from the pivot shaft 813a. The operating arms 813c extend frontward from the pivot shaft 813a. One of the operating arms 813c extends frontward from a right end of the pivot shaft 813a, while the other operating arm 813c extends frontward after extending diagonally leftward and frontward from a left end of the pivot shaft 813a.

The lower end 811b of the interlocking pin 811 is configured to abut on the pressure-receiving arm 813b as the interlocking pin 811 moves downward. When contacted by the lower end 811b of the interlocking pin 811, the pressure-receiving arm 813b moves downward, causing the interlocking arm 813 to pivot so that the operating arms 813c move upward.

The second spring 814 is a compression spring interposed between the support base 521 of the drum frame 52 and the pressure-receiving arm 813b of the interlocking arm 813. The second spring 814 urges the interlocking arm 813 in a direction for moving the pressure-receiving arm 813b upward.

The interlocking arm 813 is movable between a fifth position and a sixth position. In the fifth position, the pressure-receiving arm 813b is moved upward by the urging force of the second spring 814. In the sixth position, the pressure-receiving arm 813b is moved downward than in the fifth position against the urging force of the second spring 814.

The force-receiving pins 562e are disposed respectively on left and right side surfaces of the cylindrical portion 562a constituting the receptacle 562. The left force-receiving pin 562e protrudes leftward from the left side surface of the cylindrical portion 562a, and the right force-receiving pin 562e protrudes rightward from the right side surface of the cylindrical portion 562a.

The operating arms 813c of the interlocking arm 813 are configured to abut on the corresponding force-receiving pins 562e from below. When contacted by the operating arms 813c moving upward, the force-receiving pins 562e are pressed upward. As a result of the force-receiving pins 562e being pressed upward by the corresponding operating arms 813c, the receptacle 562 is caused to move from the first position to the second position.

[Moving the Receptacle with the Linkage]

In a state where the top cover 21 is in the first closed position and the refill cover 22 is in the second closed position, as illustrated in FIG. 5, the cam 221 and interlocking pin 811 are separated from each other. Accordingly, the interlocking pin 811 is urged to be placed at the third position by the urging force of the first spring 812.

Since the interlocking pin 811 is separated from the pressure-receiving arm 813b of the interlocking arm 813 while being in in the third position, the interlocking pin 811 is in its fifth position where the pressure-receiving arm 813b is moved upward by the urging force of the second spring 814. At this time, the operating arms 813c of the interlocking arm 813 are moved downward and separated from the corresponding force-receiving pins 562e of the receptacle 562. In other words, the fifth position of the interlocking arm 813 is such a position that the operating arms 813c are separated from the corresponding force-receiving pins 562e.

Thus, when the top cover 21 is in the first closed position and the refill cover 22 is in the second closed position, the second spring 814 urges the interlocking arm 813 into the fifth position where the operating arms 813c are separated from the corresponding force-receiving pins 562e. While the interlocking arm 813 is separated from the force-receiving pins 562e, the developing unit frame 56 is urged to move in the first direction D1 by the urging force of the compression springs 501, thereby moving the receptacle 562 to the first position where the receptacle 562 is separated from the opening 21A of the top cover 21.

As the refill cover 22 is moved toward the second open position from the state illustrated in FIG. 5, the cam 221 abuts on the interlocking pin 811 and presses the same downward in association with the movement of the refill cover 22. When pressed downward, the interlocking pin 811 moves downward against the urging force of the first spring 812 and presses the pressure-receiving arm 813b of the interlocking arm 813 downward. When pressed downward by the interlocking pin 811, the pressure-receiving arm 813b moves downward against the urging force of the second spring 814.

In other words, movement of the movement of the refill cover 22 from the second closed position toward the second open position causes the interlocking pin 811 to move, by the cam 221, from the third position to the fourth position. Further, the movement of the interlocking pin 811 from the third position to the fourth position (caused by the movement of the refill cover 22 toward the second open position) then causes the interlocking arm 813 to move from the fifth position to the sixth position.

In response to the movement of the interlocking arm 813 from the fifth position to the sixth position caused by the pressure-receiving arm 813b moving downward, the operating arms 813c of the interlocking arm 813 move upward and push the corresponding force-receiving pins 562e of the receptacle 562 upward. In other words, the force-receiving pins 562e are pressed in such a direction that the receptacle 562 moves toward the opening 21A by the interlocking arm 813 moving from the fifth position to the sixth position. As the force-receiving pins 562e are pressed upward, the receptacle 562 moves from the first position to the second position against the urging force of the compression springs 501.

By configuring the linkage 81 to include the cam 221, interlocking pin 811, interlocking arm 813, and force-receiving pins 562e in this way, the linkage 81 can easily move the receptacle 562 toward the opening 21A in conjunction with the movement of the refill cover 22 from the second closed position to the second open position.

Since the interlocking pin 811 is arranged on the top cover 21, the interlocking pin 811 can be separated away from the opening 2A together with the top cover 21 in interlocking relation to the movement of the top cover 21 from the first closed position to the first open position. Hence, the developing unit 55 and drum unit 51 can be removed from the main housing 2 through the opening 2A without interference with the interlocking pin 811. Further, since the interlocking arm 813 is disposed on the drum unit 51, the interlocking arm 813 can be removed from the main housing 2 together with the drum unit 51 when the drum unit 51 is removed from the main housing 2. Hence, the interlocking arm 813 does not hinder user's detachment of the drum unit 51 from the main housing 2.

Conversely, when the refill cover 22 is moved toward the second closed position from the state illustrated in FIG. 7 where the top cover 21 is in the first closed position, the refill cover 22 is in the second open position, and the receptacle 562 is in the second position, the downward pressure applied to the interlocking pin 811 from the cam 221 is released in conjunction with the movement of the refill cover 22, as illustrated in FIG. 5. The interlocking pin 811 then moves upward from the fourth position to the third position by the urging force of the first spring 812, since the cam 221 no longer pushes the interlocking pin 811 downward.

When the interlocking pin 811 is moved to the third position from the fourth position, the downward pressure applied from the interlocking pin 811 is removed from the pressure-receiving arm 813b of the interlocking arm 813. Upon removal of the downward pressure from the interlocking pin 811, the pressure-receiving arm 813b is moved upward by the urging force of the second spring 814, moving the interlocking arm 813 from the sixth position to the fifth position.

Upon arrival of the interlocking arm 813 at the fifth position in response to the upward movement of the pressure-receiving arm 813b, the operating arms 813c move downward to be separated from the corresponding force-receiving pins 562e. Upon separation of the operating arms 813c from the force-receiving pins 562e, the developing unit frame 56 is caused to move in the first direction D1 by the urging force of the compression springs 501, thereby moving the receptacle 562 from the second position to the first position.

In this way, when the refill cover 22 is moved to the second closed position while the top cover 21 is in the first closed position, the interlocking arm 813 is caused to move away from the force-receiving pins 562e by the upward urging force of the second spring 814. As a result, since the interlocking arm 813 no longer applies upward pressure to the force-receiving pins 562e, the receptacle 562 is allowed to move to the first position. Further, since the interlocking arm 813 is now separated from the force-receiving pins 562e, the developing unit 55 can move relative to the drum unit 51 without hindrance by the interlocking arm 813.

As described above, the linkage 81 is configured to: move the receptacle 562 to the first position while the top cover 21 is in the first closed position and the refill cover 22 in the second closed position; and move the receptacle 562 to the second position while the top cover 21 is in the first closed position and the refill cover 22 is in the second open position.

Incidentally, as illustrated in FIG. 4, the receptacle 562 and the linkage 81 are arranged outside an area within which the exposure unit 41 can irradiate its laser light toward the photosensitive drum 53. This arrangement of the receptacle 562 and linkage 81 does not obstruct the laser light emitted by the exposure unit 41 toward the photosensitive drum 53.

### [Unit-Side Shutter]

As illustrated in FIGS. 6, 8A through 9B, the developing unit 55 includes a unit-side shutter 83 configured to open and close the supply port 562c of the receptacle 562. The unit-side shutter 83 is accommodated in the receptacle 562 of the developing unit 55. The unit-side shutter 83 is an example of “unit-side shutter” of the disclosure.

The unit-side shutter 83 has a cylindrical portion 831, a bottom portion 832, an opening 833, and an engaging protrusion 834. The engaging protrusion 834 is an example of “second receiving part” of the disclosure.

The cylindrical portion 831 has a cylindrical shape elongated in the up-down direction. The cylindrical portion 831 has an open top end. The bottom portion 832 is a plate-shaped member that closes a bottom end of the cylindrical portion 831.

The cylindrical portion 831 has an outer circumferential surface that opposes an inner circumferential surface of the cylindrical portion 562a of the receptacle 562. The bottom portion 832 has a bottom surface that opposes the top surface of the bottom portion 562b of the receptacle 562. An elongate hole 832a is formed in the bottom portion 832. The elongate hole 832a extends in a direction along a circumference of the bottom portion 832. The anchoring pin 562d of the receptacle 562 is inserted in the elongate hole 832a from below.

The opening 833 is formed in the cylindrical portion 831 and the bottom portion 832. The engaging protrusion 834 protrudes radially inward from an inner circumferential surface of the cylindrical portion 831 and extends in the up-down direction.

The engaging protrusion 834 is positioned at an upper end portion on the inner circumferential surface of the cylindrical portion 831 in the up-down direction. The opening 833 and engaging protrusion 834 are arranged at positions out of phase from each other in a circumferential direction of the cylindrical portion 831, for example. In the present embodiment, the opening 833 is located on the right-rear side of the cylindrical portion 831 and bottom portion 832 when the engaging protrusion 834 is positioned on the front side of the cylindrical portion 831, whereas the opening 833 is located on the left-rear side of the cylindrical portion 831 and bottom portion 832 when the engaging protrusion 834 is positioned on the right side of the cylindrical portion 831.

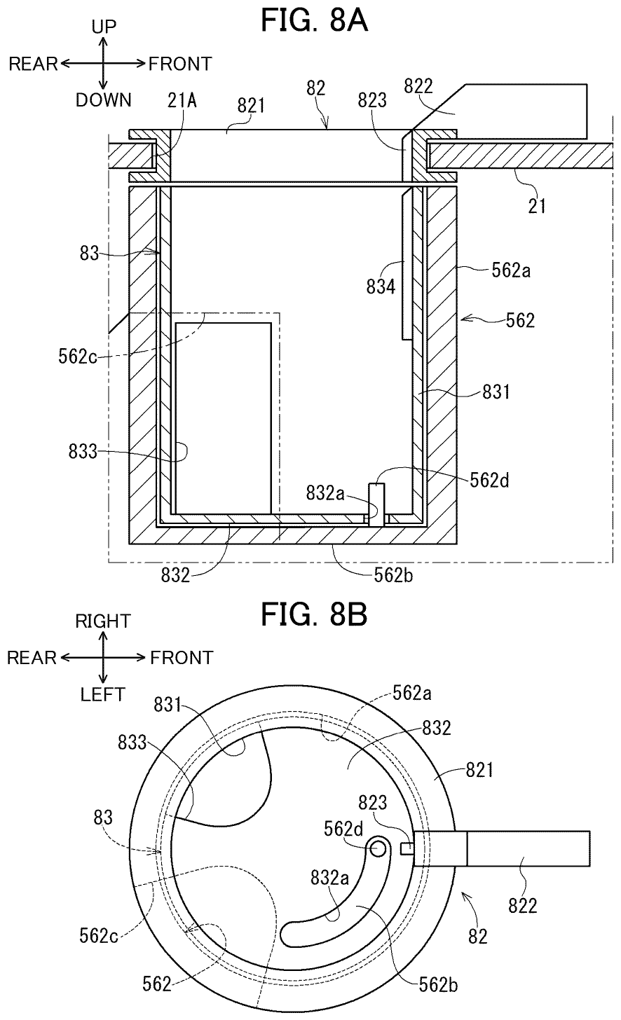

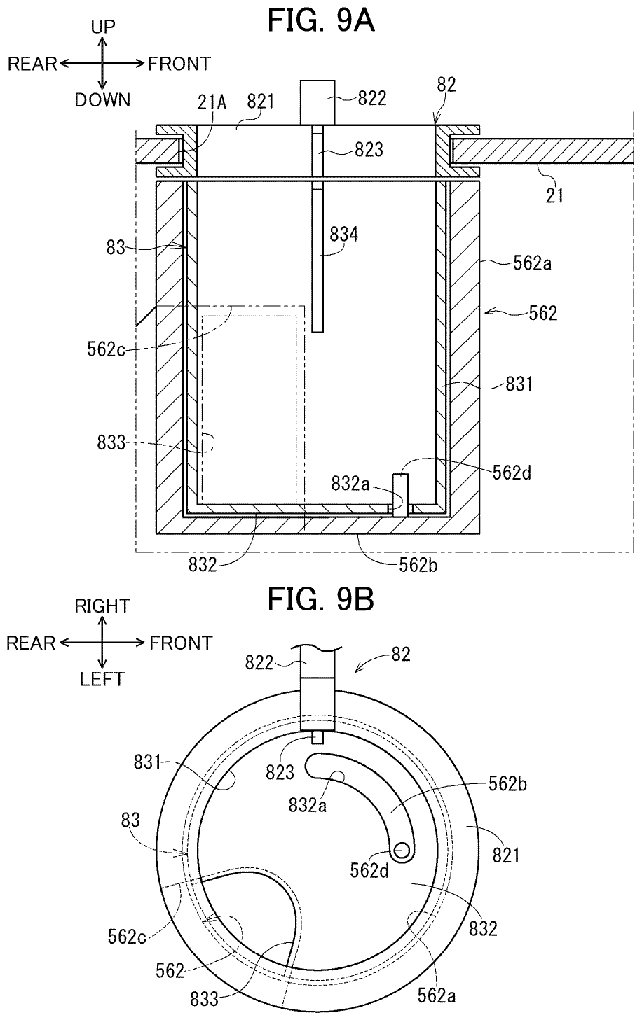

The unit-side shutter 83 is pivotable inside the receptacle 562 about a pivot axis extending in the up-down direction. By pivoting about this pivot axis, the unit-side shutter 83 is movable between a first shutter closed position (illustrated in FIG. 8) in which the opening 833 is on the right-rear side, and a first shutter open position (illustrated in FIG. 9) in which the opening 833 is on the left-rear side.

When the unit-side shutter 83 is in the first shutter closed position, the supply port 562c of the receptacle 562 and the opening 833 of the unit-side shutter 83 are out of phase in the circumferential direction, and the supply port 562c is thus closed by the unit-side shutter 83.

When the unit-side shutter 83 is in the first shutter open position, the supply port 562c of the receptacle 562 and the opening 833 of the unit-side shutter 83 are in the same phase in the circumferential direction, and the supply port 562c is exposed by the unit-side shutter 83.

The engaging protrusion 834 is positioned on the front side when the unit-side shutter 83 is in the first shutter closed position and on the right side when the unit-side shutter 83 is in the first shutter open position. The engaging protrusion 834 is movable between the front side and the right side in association with the movement of the unit-side shutter 83 between the first shutter closed position and the first shutter open position.

The anchoring pin 562d of the receptacle 562 can move relative to the unit-side shutter 83 inside the elongate hole 832a of the bottom portion 832. The anchoring pin 562d is movable within the elongate hole 832a in association with the pivotal movement of the unit-side shutter 83.

When the unit-side shutter 83 is in the first shutter closed position, the anchoring pin 562d is at an upstream end of the elongate hole 832a in the clockwise direction when viewed from above (see FIG. 8B). When the unit-side shutter 83 is in the first shutter open position, the anchoring pin 562d is at a downstream end of the elongate hole 832a in the clockwise direction when viewed from above (see FIG. 9B).

### [Operating Member]

As illustrated in FIGS. 5 and 7 through 9B, the top cover 21 includes an operating member 82. The operating member 82 includes a ring-shaped member 821, an operating lever 822, and an engaging protrusion 823. The engaging protrusion 823 is an example of “first engaging part” of the disclosure.

The ring-shaped member 821 is formed in an annular shape. The ring-shaped member 821 is disposed on a periphery of the opening 21A in the top cover 21 such that the ring-shaped member 821 is rotatable relative to the opening 21A. The operating lever 822 extends radially outward from the ring-shaped member 821.

The operating member 82 can be rotated by user's gripping the operating lever 822 with his fingers and moving the operating lever 822 in a circumferential direction of the operating member 82. The engaging protrusion 823 protrudes radially inwardly from an inner circumferential surface of the ring-shaped member 821 and extends in the up-down direction.

The operating lever 822 and engaging protrusion 823 are arranged at the same phase in the circumferential direction, for example. In FIGS. 5, 7 through 8B, the operating lever 822 and engaging protrusion 823 are located on the front side of the operating member 82. In FIGS. 9A and 9B, the operating lever 822 and engaging protrusion 823 are positioned on the right side of the operating member 82.

The operating member 82 is in a first operating position when the operating lever 822 and engaging protrusion 823 are on the front side and in a second operating position when the operating lever 822 and engaging protrusion 823 are on the right side. The operating member 82 is rotatable between the first operating position and second operating position. The engaging protrusion 823 is configured to move between the front side and the right side in association with the rotation of the operating member 82 between the first operating position and the second operating position.

### [Toner Container]

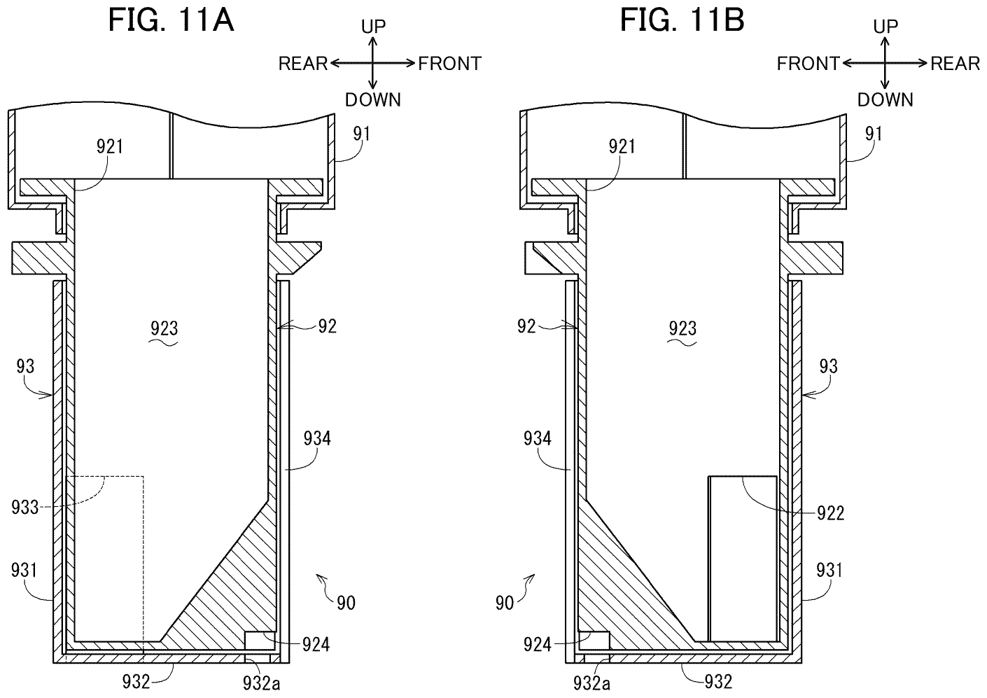

FIGS. 10A through 12B illustrate the toner container 90 for replenishing the process cartridge 50 with toner. The toner container 90 is an example of “toner container” of the disclosure.

The toner container 90 includes a container body 91 that stores toner, a discharging part 92 connectable to the receptacle 562 of the process cartridge 50, and a container-side shutter 93 disposed on the discharging part 92. The discharging part 92 is an example of “discharging part” of the disclosure. The container-side shutter 93 is an example of “container-side shutter” of the disclosure.

The container body 91 is a bag-shaped member formed by bonding together flexible film-like members. The discharging part 92 has a cylindrical shape that extends downward from a bottom end of the container body 91. The discharging part 92 has an inlet port 921, an outlet port 922, an outlet channel 923, and a pin groove 924. The inlet port 921 is open in a top surface of the discharging part 92. The outlet port 922 is open on both an outer circumferential surface and a bottom surface of the discharging part 92 on a left-rear side thereof. The outlet channel 923 connects the inlet port 921 to the outlet port 922. The pin groove 924 is formed in a bottom endface of the discharging part 92.

The toner stored in the container body 91 can flow into the discharging part 92 through the inlet port 921, and then be discharged out of the toner container 90 through the outlet port 922 after flowing through the outlet channel 923.

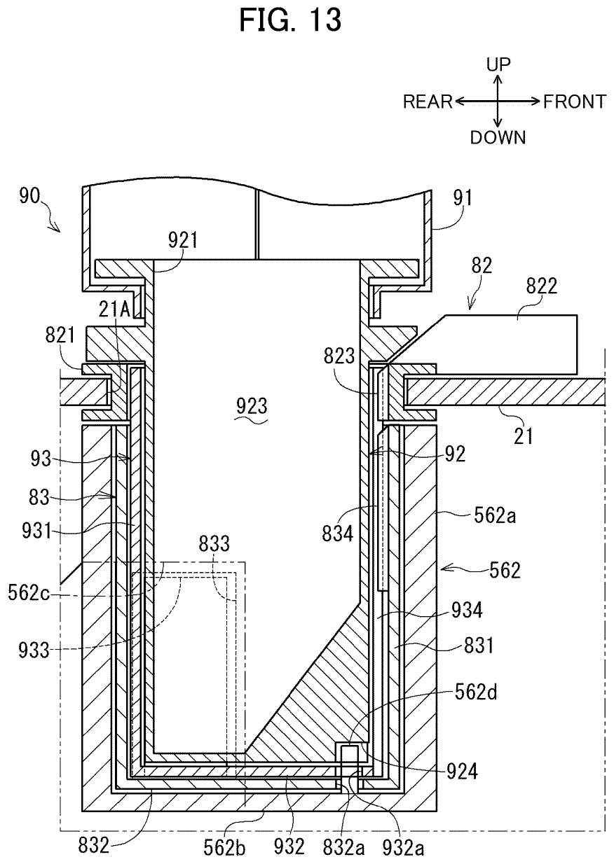

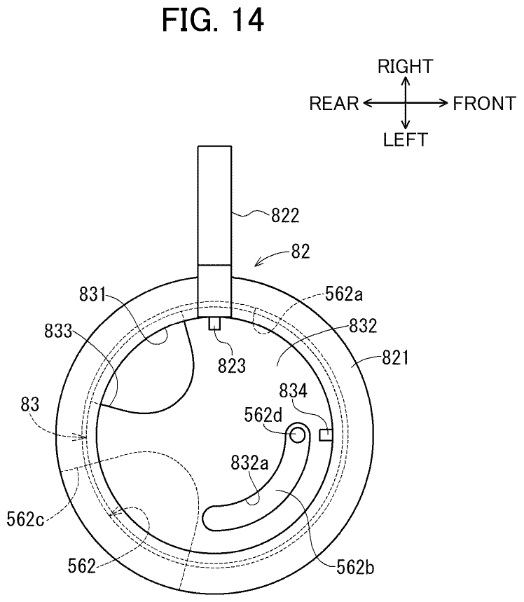

The discharging part 92 can be inserted into the opening 21A of the top cover 21. After passing through the opening 21A from above, the discharging part 92 can be further inserted into the receptacle 562 of the process cartridge 50. By inserting the discharging part 92 into the receptacle 562, the discharging part 92 and receptacle 562 are connected to each other. In a state where the discharging part 92 is connected to the receptacle 562, the anchoring pin 562d of the receptacle 562 is inserted in the pin groove 924 formed in the discharging part 92 (see FIG. 13). The pin groove 924 is an example of “third receiving part” of the disclosure.

Since the anchoring pin 562d is inserted in the pin groove 924 while the discharging part 92 is connected to the receptacle 562, the anchoring pin 562d engages the pin groove 924, thereby restricting an attempt to rotate the discharging part 92 about an axis thereof aligned in the up-down direction. While the discharging part 92 is connected to the receptacle 562, the supply port 562c of the receptacle 562 and the outlet port 922 of the discharging part 92 are in phase in the circumferential direction.

The container-side shutter 93 is arranged to cover the discharging part 92 from outside thereof. The container-side shutter 93 has a cylindrical portion 931, a bottom portion 932, an opening 933, and an engaging groove 934. The engaging groove 934 is an example of “first receiving part” of the disclosure. The engaging groove 934 is also an example of “second engaging part” of the disclosure.

The cylindrical portion 931 has a hollow cylindrical shape that is elongated in the up-down direction. The cylindrical portion 931 has an open top end. The bottom portion 932 is a plate-shaped member that closes a bottom end of the cylindrical portion 931. The discharging part 92 is inserted in the container-side shutter 93 from the open top end of the cylindrical portion 931, at which time the cylindrical portion 931 covers the outer circumferential surface of the discharging part 92 and the bottom portion 932 covers the bottom endface of the discharging part 92.

The cylindrical portion 931 has an inner circumferential surface that opposes the outer circumferential surface of the discharging part 92. A top surface of the bottom portion 932 opposes the bottom endface of the discharging part 92. An elongate hole 932a is formed in the bottom portion 932. The elongate hole 932a extends in a circumferential direction of the bottom portion 932. The anchoring pin 562d of the receptacle 562 can be inserted into the elongate hole 932a from below.

The opening 933 is formed in the cylindrical portion 931 and the bottom portion 932. The engaging groove 934 is a groove that extends in the up-down direction and that is recessed radially inward from an outer circumferential surface of the cylindrical portion 931. The engaging groove 934 extends from the top end to the bottom end of the cylindrical portion 931. In the present embodiment, the engaging groove 934 has a slit-like shape, the slit being formed by a part of the cylindrical portion 931 in the circumferential direction being cut out so as to extend through the cylindrical portion 931 in a thickness direction thereof. The opening 933 and engaging groove 934 are arranged to be out of phase in the circumferential direction of the cylindrical portion 931, for example.

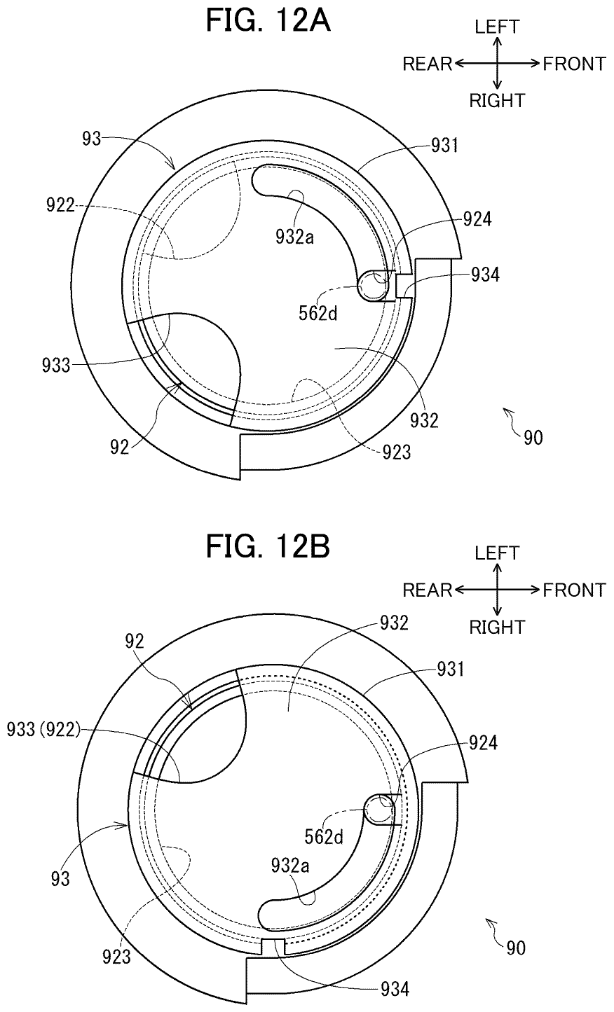

The container-side shutter 93 can pivot about a pivot axis thereof extending in the up-down direction. By pivoting the container-side shutter 93 about this pivot axis, the container-side shutter 93 is movable between a second shutter closed position (illustrated in FIG. 12A) in which the opening 933 is on the right-rear side, and a second shutter open position (illustrated in FIG. 12B) in which the opening 933 is on the left-rear side.

When the container-side shutter 93 is in the second shutter closed position, the outlet port 922 of the discharging part 92 and the opening 933 of the container-side shutter 93 are out of phase in the circumferential direction so that the container-side shutter 93 covers the outlet port 922.

When the container-side shutter 93 is in the second shutter open position, the outlet port 922 of the discharging part 92 and the opening 933 of the container-side shutter 93 are in phase in the circumferential direction so that the container-side shutter 93 exposes the outlet port 922.

The engaging groove 934 is located on the front side when the container-side shutter 93 is in the second shutter closed position and on the right side when the container-side shutter 93 is in the second shutter open position. The engaging groove 934 is configured to move between the front side and the right side in association with the movement of the container-side shutter 93 between the second shutter closed position and second shutter open position.

The anchoring pin 562d of the receptacle 562 is configured to move within the elongate hole 932a of the bottom portion 932 as the container-side shutter 93 is pivoted. The anchoring pin 562d is thus movable relative to the bottom portion 932 (elongate hole 932a) of the container-side shutter 93.

When the container-side shutter 93 is in the second shutter closed position, the anchoring pin 562d is at a downstream end of the elongate hole 932a in the clockwise direction when viewed from below (see FIG. 12A). When the container-side shutter 93 is in the second shutter open position, the anchoring pin 562d is at an upstream end of the elongate hole 932a in the clockwise direction when viewed from below (see FIG. 12B).

[Replenishing the Process Cartridge with Toner from the Toner Container]

As illustrated in FIG. 2, the receptacle 562 on the developing unit frame 56 can be exposed outside by moving the refill cover 22 to the second open position while the top cover 21 is in the first closed position. With the receptacle 562 exposed to the outside, the discharging part 92 of the toner container 90 can be connected to the receptacle 562.

To connect the discharging part 92 of the toner container 90 to the receptacle 562, the discharging part 92 of the toner container 90 is inserted into the receptacle 562 while the container-side shutter 93 is in the second shutter closed position. At the same time, the unit-side shutter 83 is placed in the first shutter closed position and the operating member 82 is placed in the first operating position.

When the discharging part 92 of the toner container 90 is inserted into the receptacle 562, as illustrated in FIG. 13, the engaging groove 934 of the container-side shutter 93 is in phase in the circumferential direction with the engaging protrusion 823 of the operating member 82 and the engaging protrusion 834 of the unit-side shutter 83. Accordingly, the engaging groove 934 engages with both the engaging protrusion 823 and the engaging protrusion 834. In the present embodiment, the portion of the engaging groove 934 engaged with the engaging protrusion 823 serves as the “first receiving part” of the disclosure, while the portion of the engaging groove 934 engaged with the engaging protrusion 834 serves as the “second engaging part” of the disclosure. In other words, in the present embodiment, the first receiving part and second engaging part of the disclosure are integral with each other to constitute a single part and are disposed on the container-side shutter 93.

Although the engaging protrusion 823 and engaging protrusion 834 are engaged in the same engaging groove 934 in this embodiment, the engaging protrusion 823 may be configured to engage with an engaging groove that is formed separately from an engaging groove with which the engaging protrusion 834 is engageable. In this case, the engaging groove with which the engaging protrusion 823 is to be engaged and the engaging groove with which the engaging protrusion 834 is to be engaged are configured to operate in interlocking relation to each other.

As the discharging part 92 of the toner container 90 is inserted into the receptacle 562, the anchoring pin 562d of the receptacle 562 is inserted into the elongate hole 832a of the unit-side shutter 83 and the elongate hole 932a of the container-side shutter 93. The anchoring pin 562d is further inserted into the pin groove 924 of the discharging part 92, thereby the discharging part 92 of the toner container 90 being connected to the receptacle 562.

When the operating lever 822 is operated to rotate the operating member 82 from the first operating position to the second operating position while the discharging part 92 of the toner container 90 is connected to the receptacle 562, the container-side shutter 93 moves from the second shutter closed position to the second shutter open position in association with the rotation of the operating member 82, as illustrated in FIG. 12B, since the engaging protrusion 823 of the operating member 82 is engaged with the engaging groove 934 of the container-side shutter 93.

Further, since the engaging protrusion 834 of the unit-side shutter 83 is also engaged with the engaging groove 934 of the container-side shutter 93, the unit-side shutter 83 moves from the first shutter closed position to the first shutter open position in association with the movement of the container-side shutter 93 from the second shutter closed position to the second shutter open position, as illustrated in FIG. 9B.

In other words, the container-side shutter 93 is opened by rotating the operating member 82 from the first operating position to the second operating position while the engaging protrusion 823 of the operating member 82 is engaged with the engaging groove 934 of the container-side shutter 93. Further, the container-side shutter 93 and the unit-side shutter 83 are simultaneously opened by the operation of the operating member 82.

At this time, since rotation of the discharging part 92 is restricted by the engagement of the anchoring pin 562d of the receptacle 562 with the pin groove 924 of the discharging part 92, the discharging part 92 is restricted from rotating together with the container-side shutter 93 is association with the movement of the container-side shutter 93 from the second shutter closed position to the second shutter open position.

When the container-side shutter 93 is moved to the second shutter open position, the opening 933 in the container-side shutter 93 is moved into phase with the outlet port 922 of the discharging part 92, whereby the container-side shutter 93 opens the outlet port 922 of the discharging part 92. When the unit-side shutter 83 is moved to the first shutter open position, the opening 833 in the unit-side shutter 83 is moved into phase with the supply port 562c in the receptacle 562, whereby the unit-side shutter 83 opens the supply port 562c of the receptacle 562.

Through this operation, the outlet port 922 of the discharging part 92 and the supply port 562c of the receptacle 562 communicate with the toner chamber 57 of the developing unit 55, allowing the toner stored in the container body 91 to be supplied into the toner chamber 57 through the outlet port 922 and the supply port 562c.

After the toner chamber 57 has been completely replenished with the toner from the toner container 90, the operating lever 822 is operated to rotate the operating member 82 from the second operating position back to the first operating position. When the operating member 82 is rotated from the second operating position to the first operating position, the container-side shutter 93 moves from the second shutter open position to the second shutter closed position in association with the rotation of the operating member 82. The unit-side shutter 83 also moves from the first shutter open position to the first shutter closed position in association with the movement of the container-side shutter 93 from the second shutter open position to the second shutter closed position.

Through this operation, the container-side shutter 93 closes the outlet port 922 in the discharging part 92 and the unit-side shutter 83 closes the supply port 562c in the receptacle 562.

In other words, the container-side shutter 93 is closed by rotating the operating member 82 from the second operating position to the first operating position while the engaging protrusion 823 of the operating member 82 is engaged with the engaging groove 934 of the container-side shutter 93. Thus, the container-side shutter 93 and the unit-side shutter 83 are simultaneously closed by operating the operating member 82.

After the operating lever 822 is rotated from the second operating position back to the first operating position to close the outlet port 922 in the discharging part 92 and the supply port 562c in the receptacle 562, the discharging part 92 of the toner container 90 is removed from the receptacle 562.

After the discharging part 92 of the toner container 90 is removed from the receptacle 562, the refill cover 22 is moved back to the second closed position to close the opening 21A. By closing the opening 21A with the refill cover 22 so that the receptacle 562 is covered from above by the refill cover 22, entry of dusts and other foreign matters into the receptacle 562 through the opening 21A can be restrained while the toner container 90 is not connected to the receptacle 562.

In this way, the operating member 82 is configured to operate (move) the container-side shutter 93 disposed around the discharging part 92 for opening and closing the outlet port 922 in the discharging part 92 while the discharging part 92 of the toner container 90 is connected to the receptacle 562.

Therefore, when the toner container 90 is connected to the receptacle 562, the container-side shutter 93 of the toner container 90 can be easily opened and closed through the operating member 82. Further, since the receptacle 562 has been moved to the second position near the opening 21A by the linkage 81 when the refill cover 22 is in the second open position, the discharging part 92 of the toner container 90 can be easily mounted in the receptacle 562. Thus, this configuration can facilitate operations for mounting the discharging part 92 of the toner container 90 in the receptacle 562 of the developing unit 55 and opening and closing the container-side shutter 93 of the toner container 90.

Further, since the operating member 82 is disposed on the top cover 21 and moves together with the top cover 21 as the top cover 21 is opened and closed, the operating member 82 does not interfere with operations for mounting and removing the process cartridge 50 in and from the main housing 2 through the opening 2A. Thus, this configuration can facilitate operations for mounting the process cartridge 50 in and removing the process cartridge 50 from the main housing 2.

Further, the operating member 82 is configured to open and close the container-side shutter 93 by being rotated while the engaging protrusion 823 of the operating member 82 is engaged with the engaging groove 934 of the container-side shutter 93. With this configuration, the container-side shutter 93 of the toner container 90 can be easily opened and closed by operating the operating lever 822 to rotate the operating member 82 while the toner container 90 is connected to the receptacle 562.

Further, the operating member 82 can open and close the container-side shutter 93 and unit-side shutter 83 simultaneously in the embodiment. With this configuration, both the container-side shutter 93 and unit-side shutter 83 can be opened and closed easily by a simple operation to the operating member 82

The container-side shutter 93 of the toner container 90 has the engaging groove 934 engageable with the engaging protrusion 823 of the operating member 82, and the developing unit 55 has the engaging protrusion 834 engageable with the engaging groove 934 and movable in association with the unit-side shutter 83. Accordingly, the container-side shutter 93 and the unit-side shutter 83 can be simultaneously opened and closed simply by rotating the operating member 82.

Since the engaging groove 934 is disposed in the container-side shutter 93 and the engaging protrusion 834 is disposed on the unit-side shutter 83, the configurations of the discharging part 92 in the toner container 90 and the receptacle 562 in the developing unit 55 can be simplified.

The anchoring pin 562d of the receptacle 562 is engaged in the pin groove 924 of the discharging part 92 while the discharging part 92 of the toner container 90 is connected to the receptacle 562. This engagement can restrict the discharging part 92 of the toner container 90 from rotating together with the operating member 82, which would result in the container-side shutter 93 being unable to open and close the discharging part 92 when the operating member 82 is rotated.

In the image-forming apparatus 1 having the above configuration, while the top cover 21 is in the first closed position and the refill cover 22 in the second closed position, the interlocking arm 813 of the linkage 81 is separated from the force-receiving pins 562e of the receptacle 562 and the developing unit 55 is configured to move relative to the drum unit 51.

On the other hand, while the top cover 21 is in the first closed position and the refill cover 22 in the second open position, the interlocking arm 813 presses the force-receiving pins 562e of the receptacle 562 upward, enabling the linkage 81 to move the receptacle 562 into the second position against the urging force of the compression springs 501. Accordingly, the developing unit 55 is fixed in position relative to the drum unit 51.

With this configuration, when the discharging part 92 of the toner container 90 is to be connected to the receptacle 562 of the developing unit 55 after the refill cover 22 is moved to the second open position, the position of the developing unit 55 is fixed relative to the drum unit 51, stabilizing the connection between the developing unit frame 56 and the discharging part 92. Further, when the refill cover 22 is in the second closed position and the discharging part 92 of the toner container 90 is not connected to the receptacle 562 of the developing unit 55, the developing unit 55 is allowed to move relative to the drum unit 51 without being impeded by the linkage 81.

In the present embodiment, a gap exists between the receptacle 562 and the top cover 21 while the receptacle 562 is in the second position and the top cover 21 is in the first closed position, as illustrated in FIG. 7. However, the receptacle 562 may be configured to contact the top cover 21 when moved into the second position.

By configuring the receptacle 562 to contact the top cover 21 when the receptacle 562 is in the second position in this way, the developing unit 55 can be fixed in position relative to the main housing 2, ensuring a stable connection between the receptacle 562 of the developing unit 55 and the discharging part 92 of the toner container 90. Further, in this case, since the receptacle 562 is separated from the top cover 21 when in the first position, the developing unit 55 can move relative to the drum unit 51 while the receptacle 562 is in the first position.

### [Relationship Between Operating Member and Refill Cover]

As illustrated in FIG. 13, in a state where the operating member 82 is in the first operating position, the engaging protrusion 823 of the operating member 82 and the engaging protrusion 834 of the unit-side shutter 83 are both positioned on the front side and, thus, are in phase in the circumferential direction.

In this state, both the engaging protrusion 823 and the engaging protrusion 834 can be engaged in the engaging groove 934 of the container-side shutter 93 when the discharging part 92 of the toner container 90 is inserted into the receptacle 562 through the opening 21A. In other words, the first operating position of the operating member 82 is such a position at which the discharging part 92 of the toner container 90 is allowed to be connected to the receptacle 562 of the process cartridge 50.

Further, if the operating member 82 is to be rotated from the first operating position to the second operating position while the discharging part 92 of the toner container 90 is not inserted in the receptacle 562, the engaging protrusion 823 of the operating member 82 is to move from the front side to the right side. However, since the engaging protrusion 823 of the operating member 82 is separated from the engaging protrusion 834 of the unit-side shutter 83, the engaging protrusion 834 of the unit-side shutter 83 remains in its position on the front side. That is, the phase of the engaging protrusion 823 on the operating member 82 is to be offset from the phase of the engaging protrusion 834 on the unit-side shutter 83.

Thus, if the discharging part 92 of the toner container 90 is to be inserted into the receptacle 562 while the operating member 82 is in the second operating position, the engaging groove 934 and the engaging protrusion 823 could be engaged with each other by aligning the phases for the engaging groove 934 of the container-side shutter 93 and the engaging protrusion 823 of the operating member 82.

However, since the phase of the engaging protrusion 823 on the operating member 82 in this case is offset from the phase of the engaging protrusion 834 on the unit-side shutter 83, the engaging groove 934 of the container-side shutter 93 cannot be engaged with the engaging protrusion 834 of the unit-side shutter 83 and, hence, the discharging part 92 cannot be inserted all the way into the receptacle 562. In other words, the second operating position of the operating member 82 is such a position at which the discharging part 92 of the toner container 90 cannot be connected to the receptacle 562 of the process cartridge 50.

As illustrated in FIGS. 5 and 7, the refill cover 22 has a groove 22b. The groove 22b is recessed upward from the bottom surface of the refill cover 22 in a state where the refill cover 22 is in the second closed position. In this embodiment, the groove 22b extends through the refill cover 22 in the up-down direction in the state where the refill cover 22 is in the second closed position. However, the groove 22b need not extend through the refill cover 22 entirely but may be closed on the top side. The groove 22b is an example of “groove” of the disclosure.

The groove 22b is formed at a position and in a shape for fitting over the operating lever 822 of the operating member 82 when the operating member 82 is in the first operating position and the refill cover 22 is moved into the second closed position. The groove 22b cannot be fitted over the operating lever 822 when the operating member 82 is in the second operating position or any other position deviating from the first operating position.

Hence, when the refill cover 22 is moved from the second open position toward the second closed position while the operating member 82 is in the first operating position, the operating lever 822 is fitted into the groove 22b, enabling the refill cover 22 to move into the second closed position.

On the other hand, if the refill cover 22 is moved from the second open position toward the second closed position while the operating member 82 is in the second operating position or any position deviating from the first operating position, the operating lever 822 contacts the bottom surface of the refill cover 22 rather than being fitted into the groove 22b, restricting the refill cover 22 from moving all the way into the second closed position. In other words, when the operating member 82 is in the second operating position, the refill cover 22 cannot be closed completely.

Thus, by checking whether the refill cover 22 has been moved completely into the second closed position when moving the refill cover 22 toward the second closed position, the user can easily determine whether the operating member 82 is in the first operating position in which the discharging part 92 can be connected to the receptacle 562.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### [Variations of the First Engaging Part, First Receiving Part, Second Engaging Part, and Second Receiving Part]

In the embodiment described above, the engaging protrusion 823 (as the first engaging part) is disposed on the operating member 82; the engaging protrusion 834 (as the second receiving part) is disposed on the unit-side shutter 83; and the engaging groove 934 (as the first receiving part and as the second engaging part) is disposed on the container-side shutter 93.

However, an engaging groove may be formed in the operating member 82 as the first engaging part; an engaging groove may be formed in the unit-side shutter 83 as the second receiving part; and an engaging protrusion may be formed on the container-side shutter 93 as the first receiving part engageable with the engaging groove of the operating member 82 and as the second engaging part (engageable with the engaging groove of the unit-side shutter 83).

Alternatively, an engaging protrusion may be formed on the operating member 82 as the first engaging part; an engaging groove may be formed in the unit-side shutter 83 as the second receiving part; and the container-side shutter 93 may have an engaging groove as the first receiving part engageable with the engaging protrusion (first engaging part) of the operating member 82 and an engaging protrusion as the second engaging part engageable with the engaging groove (second receiving part) of the unit-side shutter 83.

Still alternatively, an engaging groove may be formed in the operating member 82 as the first engaging part; an engaging protrusion may be formed on the unit-side shutter 83 as the second receiving part; an engaging protrusion may be formed on the container-side shutter 93 as the first receiving part engageable with the engaging groove (first engaging part) of the operating member 82; and an engaging groove may be formed in the container-side shutter 93 as the second engaging part engageable with the engaging protrusion (second receiving part) of the unit-side shutter 83.

### [Variations of the Third Engaging Part and the Third Receiving Part]

In the embodiment described above, the anchoring pin 562d is formed on the receptacle 562 as the third engaging part, and the pin groove 924 is formed on the discharging part 92 of the toner container 90 as the third receiving part engageable with the anchoring pin 562d (third engaging part). However, an anchoring pin may be formed on the discharging part 92 as the third receiving part, and a pin groove may be formed in the receptacle 562 as the third engaging part engageable with the anchoring pin (third receiving part) on the discharging part 92.

What is claimed is:

1. An image-forming apparatus comprising:
a main housing having a first opening;
a drum unit mountable in and removable from the main housing through the first opening, the drum unit including a photosensitive drum;
a developing unit mountable in and removable from the main housing through the first opening, the developing unit being movable relative to the drum unit, the developing unit including:
a receptacle to which a discharging part of a toner container storing toner is connectable; and
a unit-side shutter configured to open and close the receptacle;
a first cover disposed at the main housing and movable relative to the main housing between a first closed position for closing the first opening and a first open position for exposing the first opening, the first cover having a second opening configured to communicate with the receptacle, the first cover including an operating member configured to open and close the unit-side shutter;
a second cover disposed on the first cover and movable relative to the first cover between a second closed position for closing the second opening and a second open position for exposing the second opening; and
a linkage configured to move the receptacle relative to the first cover between:
a first position in which the receptacle is spaced apart from the second opening; and
a second position in which the receptacle is closer to the second opening than when in the first position,
wherein, in a state where the first cover is in the first closed position,
movement of the second cover to the second closed position causes the linkage to move the receptacle to the first position, and
movement of the second cover to the second open position causes the linkage to move the receptacle to the second position.

2. The image-forming apparatus according to claim 1,
wherein the linkage comprises:
a first member disposed on the second cover;
a first interlocking member disposed on the first cover and movable from a third position to a fourth position;
a second interlocking member disposed on the drum unit and movable from a fifth position to a sixth position; and
a second member disposed on the developing unit, and
wherein
movement of the second cover from the second closed position to the second open position causes the first member to move the first interlocking member from the third position to the fourth position;
movement of the first interlocking member from the third position to the fourth position causes the second interlocking member to move from the fifth position to the sixth position; and
movement of the second interlocking member from the fifth position to the sixth position causes the second member to be urged to move the receptacle toward the second opening.

3. The image-forming apparatus according to claim 2,
wherein the linkage further comprises an urging member urging the second interlocking member toward the fifth position,
wherein, in the fifth position, the second interlocking member is separated from the second member, and
wherein, in the sixth position, the second interlocking member is in contact with the second member.

4. The image-forming apparatus according to claim 2,
wherein the linkage further comprises an urging member urging the first interlocking member toward the third position,
wherein, in the third position, the first interlocking member is separated from the second interlocking member, and
wherein, in the fourth position, the first interlocking member is in contact with the second interlocking member.

5. The image-forming apparatus according to claim 2,
wherein the first member is a cam, and
wherein the second member is a protrusion protruding from the receptacle.

6. The image-forming apparatus according to claim 1,
wherein, in the state where the first cover is in the first closed position,
the receptacle is in contact with the first cover in the second position, and
the receptacle is separated from the first cover in the first position.

7. The image-forming apparatus according to claim 6,
wherein the developing unit is fixed in position relative to the drum unit in a state where the first cover is in the first closed position and the second cover is in the second open position, and
wherein the developing unit is movable relative to the drum unit in a state where the first cover is in the first closed position and the second cover is in the second closed position.

8. The image-forming apparatus according to claim 1,
wherein, in a state where the first cover is in the first closed position and the receptacle is in the second position, a gap is formed between the receptacle and the first cover.

9. The image-forming apparatus according to claim 8,
wherein the developing unit is fixed in position relative to the drum unit in a state where the first cover is in the first closed position and the second cover is in the second open position, and
wherein the developing unit is movable relative to the drum unit in a state where the first cover is in the first closed position and the second cover is in the second closed position.

10. The image-forming apparatus according to claim 1,
wherein the operating member comprises:
a ring-shaped member fitted over a periphery of the second opening in the first cover, the ring-shaped member being rotatable relative to the second opening;
an operating lever extending radially outward from the ring-shaped member; and
a first engaging part disposed on an inner circumferential surface of the ring-shaped member, the first engaging part being engageable with a first receiving part of the toner container, the first receiving part of the toner container being movable in association with movement of a container-side shutter disposed around the discharging part of the toner container, and
wherein rotation of the operating member opens and closes the container-side shutter in a state where the first engaging part is engaged with the first receiving part.

11. The image-forming apparatus according to claim 10,
wherein the operating member is configured to open and close both the unit-side shutter and the container-side shutter simultaneously.

12. The image-forming apparatus according to claim 11,
wherein the developing unit further includes a second receiving part engageable with a second engaging part of the toner container, the second engaging part of the toner container being movable in association with movement of the first receiving part of the toner container, and
wherein movement of the second receiving part causes movement of the unit-side shutter.

13. The image-forming apparatus according to claim 12,
wherein the first receiving part and the second engaging part are disposed on the container-side shutter, and
wherein the second receiving part is disposed on the unit-side shutter.

14. The image-forming apparatus according to claim 13,
wherein the first receiving part and the second engaging part are integral with each other on the container-side shutter.

15. The image-forming apparatus according to claim 12,
wherein the developing unit further includes a third engaging part engageable with a third receiving part of the toner container, and
wherein the third engaging part is engaged with the third receiving part in a state where the discharging part of the toner container is connected to the receptacle of the developing unit.

16. The image-forming apparatus according to claim 1,
wherein the second cover has a groove,
wherein the operating member is rotatable relative to the first cover between:
a first operating position in which the operating member is fitted in the groove; and
a second operating position in which the operating member is not fitted in the groove, and
wherein,
in a state where the operating member is at the first operating position, the discharging part of the toner container is connectable to the receptacle, and
in a state where the operating member is at the second operating position, the discharging part of the toner container is not connectable to the receptacle.
